(19) United States
(12) Patent Application Publication
(10) Pub. No.: US 2024/0070901 A1
(43) Pub. Date: Feb. 29, 2024

(54) Strabismic Pupil Positioning Method, Apparatus, Computer-Readable Storage Medium and Device

(71) Applicants: BEIJING EYECOOL TECHNOLOGY CO., LTD., Beijing (CN); EYECOOL TECHNOLOGY CO., LTD., Baoding City, Hebei (CN); SHENZHEN EYECOOL TECHNOLOGY CO., LTD., Shenzhen, Guangdong (CN)

(72) Inventor: Yang LIU, Beijing (CN)

(21) Appl. No.: 18/268,604

(22) PCT Filed: Oct. 14, 2021
(86) PCT No.: PCT/CN2021/123740

§ 371 Date: Jun. 21, 2023

(30) Foreign Application Priority Data
Dec. 30, 2020 (CN) 202011610271.0

(51) Int. Cl. G06T 7/73; G06T 7/00; G06T 7/13; G06T 7/136; G06T 7/60

(52) U.S. Cl. CPC G06T 7/73; G06T 7/0012; G06T 7/13; G06T 7/136; G06T 7/60; G06T 2207/20021; G06T 2207/30041

(57) ABSTRACT

The present disclosure discloses a strabismic pupil positioning method, apparatus, a readable storage medium and a device, and belongs to the field of iris recognition. The strabismic pupil positioning method includes: performing initial positioning on a pupil boundary to be positioned as a circle on an iris image; with an initial positioning result as a reference, dividing the iris image into multiple sub-images based on a certain central angle; for each sub-image, traversing a circle center search range and a radius search range, and using a circle center value and a radius value, which correspond to a maximum gray scale change as the circle center and the radius of the sub-image; and obtaining a circular arc segment of each sub-image based on the circle center, the radius and the central angle of each sub-image, and splicing the circular arc segments of all sub-images together to obtain the pupil boundary.

### CROSS-REFERENCE TO RELATED APPLICATION

The present disclosure claims the priority of Chinese Patent Application 202011610271.0, filed in on Dec. 30, 2020, and entitled “Strabismic Pupil Positioning Method, Apparatus, Computer-Readable Storage Medium and Device”, the entire contents of which are herein incorporated by reference.

### TECHNICAL FIELD

The present disclosure relates to the field of iris recognition, and in particular, to a strabismic pupil positioning method, apparatus, a computer-readable storage medium, and a device.

### BACKGROUND

The biological recognition technology is closely combined with high-tech means such as optics, acoustics, biosensors and principles of biostatistics through computers, and it utilizes inherent physiological characteristics (such as fingerprint, face, iris and the like) and behavior characteristics (such as handwriting, sound, gait and the like) of a human body to identify personal identity. Iris recognition is one of biometric feature recognition technologies, and as an important identity recognition feature, the iris has the advantages of lifelong uniqueness, stability, collectability, non-invasiveness and the like, and thus is an inevitable trend in the research and disclosure development of identity recognition.

The iris is a ring-like structure located between a pupil and a sclera, for example, parts of an outer circle of iris and an inner circle of iris as shown in FIG. 1, and a part of iris information is lost due to the occlusion of eyelids and eyelashes. The iris is 12 mm in diameter and 0.5 mm in thickness. From the perspective of recognition, interlaced subtle features in the iris, similar to filaments, stripes and other shapes, are a manifestation of the uniqueness of the iris. These features are usually texture features of the iris and are used for iris recognition.

The iris recognition mainly includes acquisition of an iris image, quality evaluation of the iris image, preprocessing of the iris image, normalization of the iris image, feature extraction of the iris image and iris feature comparison.

In the iris recognition, due to some other external conditions such as device experience and the non-cooperation of collected personnel, sometimes the pupil and the iris in a collected iris image has deformation such as strabismus, as shown in FIG. 2. In the iris recognition, a pupil boundary needs to be accurately positioned.

At present, the following two pupil boundary positioning methods are commonly used for the iris recognition:

1). The pupil is used as a circle shape for processing: gradient processing and sharpening are performed on an image at first, commonly used image sharpening methods include a Sobel algorithm, a Canny operator and the like, the image is filtered through the image sharpening method, a threshold value is set, and a pupil boundary is highlighted. Then, through using these pieces of boundary point information and using curve fitting methods such as symmetric radial transformation, least square method, Hough transformation and the like, the pupil boundary is used as the circle shape to achieve accurate positioning.

In this method, the fitting of some boundaries is inaccurate for a strabismic pupil image in FIG. 2, because the boundary of the strabismic pupil is not a circular boundary shape.

2). Point-to-point alignment is performed directly based on the pupil boundary: the pupil boundary is highlighted through using a method similar to 1), and then the pupil boundary is used as a group of point arrays, and the pupil boundary is described by means of counterclockwise or clockwise arrangement of these points.

Although this method gets rid of the limitation of the circle, noise such as eyelashes and light spots may occasionally shield some boundary points of the pupil, that is to say, the group of point arrays of the pupil boundary cannot describe these boundary points, therefore omission may be generated, thereby generating a relatively large influence in subsequent processes of unfolding, normalization and feature extraction.

### SUMMARY

In order to solve the defect of inaccurate positioning of a strabismic pupil positioning method in the prior art, at least some embodiments of the present disclosure provides a strabismic pupil positioning method, apparatus, a readable storage medium and a device, which improve the accuracy of strabismic pupil positioning, and ultimately improve the accuracy of the iris recognition.

The present disclosure provides the following embodiments.

An embodiment of the present disclosure provides a strabismic pupil positioning method, wherein the method includes:
performing initial positioning on a pupil boundary to be positioned as a circle on an iris image, to obtain a circle center of an initially positioned circle and the radius of the initially positioned circle;
with the circle center of an initially positioned circle as a center, dividing the iris image into multiple sub-images based on a certain central angle;
with the circle center of an initially positioned circle and the initially positioned radius as references, setting a circle center search range and a radius search range;
for each sub-image of the multiple sub-images, traversing the circle center search range and the radius search range, and using a circle center value and a radius value, which correspond to a maximum gray scale change as the circle center and the radius of the sub-image respectively;
obtaining a circular arc segment corresponding to the each sub-image based on a circle center, a radius and a central angle of the each sub-image, and splicing the circular arc segments of all sub-images together to obtain the pupil boundary.

In an optional embodiment, for each sub-image of the multiple sub-images, traversing the circle center search range and the radius search range, and using a circle center value and a radius value corresponding to a maximum gray scale change as the circle center and the radius of the sub-image respectively, includes:
for each sub-image of the multiple sub-images, unfolding a sector-like region image corresponding to the sub-image and has a circle center value of (x, y) and a radius search range of [r₁, r₂] into a rectangular region image;
constructing a filter with a size of n*1, and performing a convolution operation on the rectangular region image through using the filter to obtain an intermediate matrix;
performing interlaced subtraction on each row of the intermediate matrix to obtain a gradient matrix, and reserving elements greater than 0 in the gradient matrix to obtain a positive gradient matrix;
accumulating all values of each row in the positive gradient matrix, finding a maximum value from a column of column vectors obtained by accumulation as a gray scale change value of the circle center value, and respectively storing the gray scale change value and the number of rows corresponding to the gray scale change value in corresponding positions of a maximum value matrix and a radius matrix;
traversing the circle center search range, and respectively repeating the above steps on each circle center value within the circle center search range to obtain the maximum value matrix and the radius matrix; and
using a circle center value corresponding to a maximum gray scale change value in the maximum value matrix as the circle center of the sub-image, and using the number of rows in the radius matrix corresponding to the maximum gray scale change value as the radius of the sub-image.

In an optional embodiment, the iris image is respectively divided into a first sub-image, a second sub-image, a third sub-image and a fourth sub-image based on central angles of [0, π/2], [π/2, π], [π, 3π/2] and [3π/2, 2π]; and in response to the sector-like region image being unfolded into the rectangular region image, the central angles of sector-like regions respectively corresponding to the first sub-image, the second sub-image, the third sub-image and the fourth sub-image are respectively [−π/5, π/2+π/5], [π/2−π/5, π+π/5], [π−π/5, 3π/2+π/5] and [3π/2−π/5, π+π/5]; and
the circle center search range is [x₀−10, x₀+10] and [y₀−10, y₀+10], and the radius search range is [r₁, r₂], wherein (x₀, y₀) denotes the circle center of an initially positioned circle, r₁=r₀−25, r₂=r₀+25,
and r₀ denotes the initially positioned radius.

In an optional embodiment, the method further includes:
calculating a horizontal ordinate variance and a vertical coordinate variance of circle centers of all sub-images, wherein the horizontal ordinate variance represents a left-right pupil strabismus degree and the vertical coordinate variance represents an upper-lower pupil strabismus degree, and in response to the horizontal ordinate variance being greater than a set first threshold value or the vertical coordinate variance being greater than a set second threshold value, judging that the iris image does not meet requirements.

In an optional embodiment, before the iris image is divided into multiple sub-images based on the certain central angle with the circle center of an initially positioned circle as the center, the method further includes:
performing binarization processing on the iris image based on a set binarization threshold value to obtain a binary image;
performing an expansion operation on the binary image to position a light spot;
performing double-quadratic interpolation on pixel points located in the light spot on the iris image and adjacent pixel points.

An embodiment of the present disclosure provides a strabismic pupil positioning apparatus, wherein the apparatus includes:
an initial positioning module, configured to perform initial positioning on a pupil boundary to be positioned as a circle on an iris image to obtain a circle center of an initially positioned circle and the radius of the initially positioned circle;
a sub-image division module, configured to divide the iris image into multiple sub-images based on a certain central angle with the circle center of an initially positioned circle as a center;
a search range setting module, configured to set a circle center search range and a radius search range with the circle center of an initially positioned circle and the initially positioned radius as references;
a traversal module, configured to traverse the circle center search range and the radius search range, and use, as the circle center and the radius of the sub-image, a circle center value and a radius value, which corresponding to a maximum gray scale change as the circle center and the radius of the sub-image respectively, for each sub-image of the multiple sub-images;
a pupil boundary acquisition module, configured to obtain a circular arc segment corresponding to each sub-image based on a circle center, a radius and a central angle of each sub-image, and splice the circular arc segments of all sub-images together to obtain the pupil boundary.

In an optional embodiment, the traversal module includes:
an image unfolding unit, configured to unfold a sector-like region image corresponding to the sub-image and has a circle center value of (x, y) and a radius search range of [r1, r2], into a rectangular region image for the each sub-image of the multiple sub-images;
a convolution unit, configured to construct a filter with a size of n*1, and perform a convolution operation on the rectangular region image through using the filter to obtain an intermediate matrix;
a gradient calculation unit, configured to perform interlaced subtraction on each row of the intermediate matrix to obtain a gradient matrix, and reserve elements greater than 0 in the gradient matrix to obtain a positive gradient matrix;
an accumulation unit, configured to accumulate all values of the each row in the positive gradient matrix, find a maximum value from a column of column vectors obtained by accumulation as a gray scale change value of the circle center value, and respectively store the gray scale change value and the number of rows corresponding to in corresponding positions of a maximum value matrix and a radius matrix;
a first traversal unit, configured to traverse the circle center search range, and obtain the maximum value matrix and the radius matrix for each circle center value within the circle center search range;
a circle center and radius determining unit, configured to, use a circle center value corresponding to a maximum gray scale change value in the maximum value matrix as the circle center of the sub-image, and use the number of rows in the radius matrix corresponding to the maximum gray scale change value as the radius of the sub-image.

In an optional embodiment, the apparatus further includes:
a strabismus degree judging module, configured to calculate a horizontal ordinate variance and a vertical coordinate variance of the circle centers of all sub-images, wherein the horizontal ordinate variance represents a left-right pupil strabismus degree and the vertical coordinate variance represents an upper-lower pupil strabismus degree, and in response to the horizontal ordinate variance being greater than a set first threshold value or the vertical coordinate variance being greater than a set second threshold value, judge that the iris image does not meet requirements.

In an optional embodiment, the apparatus further includes:
a binarization module, configured to perform binarization processing on the iris image based on a set binarization threshold value, so as to obtain a binary image;
an image expansion module, configured to perform an expansion operation on the binary image to position a light spot; and
an interpolation module, configured to perform double-quadratic interpolation on pixel points located in the light spot on the iris image and adjacent pixel points.

An embodiment of the present disclosure provides a computer-readable storage medium, configured to store a processor-executable program, and when executed by the processor, the program implements the steps of the strabismic pupil positioning method.

An embodiment of the present disclosure provides a device for strabismic pupil positioning, including at least one processor and a memory for storing a computer-executable program, wherein when executing the computer-executable program, the processor implements the steps of the strabismic pupil positioning method.

The present disclosure has the following beneficial effects:

In the present disclosure, a circular arc of the pupil with strabismic deformation is divided into multiple angle intervals, and positioning is respectively performed in each angle interval, thereby improving the accuracy of strabismic pupil positioning, and ultimately improving the accuracy of iris recognition. Moreover, when positioning is performed in the each angle interval, the positioning of the circle center and the radius does not need to be performed again, but traversal is performed in the surrounding with the circle center of an initially positioned circle and the initially positioned radius as references, thereby shortening the positioning range, and thus having a high positioning speed.

### BRIEF DESCRIPTION OF THE DRAWINGS

FIG. 1 is a schematic diagram of an iris image of a normal iris.

FIG. 2 is a schematic diagram of an iris image with a strabismic pupil.

FIG. 3 is a flowchart of a strabismic pupil positioning method according to an embodiment of the present disclosure.

FIG. 4 is a schematic diagram of after initial positioning of the pupil.

FIG. 5 is a schematic diagram of a pupil boundary obtained by performing positioning on a first sub-image.

FIG. 6 is a schematic diagram of a pupil boundary obtained by performing positioning using the strabismic pupil positioning method of the present disclosure.

FIG. 7 is a schematic diagram of an iris image after a light spot is removed.

FIG. 8 is a flowchart of S400 in the strabismic pupil positioning method of the present disclosure.

FIG. 9 is a flowchart of the strabismic pupil positioning method according to an embodiment of the present disclosure, FIG. 10 is a flowchart of a method for removing the light spot.

FIG. 11 is a schematic diagram of a strabismic pupil positioning apparatus of according to an embodiment of the present disclosure.

FIG. 12 is a schematic diagram of a traversal module in the strabismic pupil positioning apparatus of the present disclosure.

FIG. 13 is a schematic diagram of the strabismic pupil positioning apparatus according to an embodiment of the present disclosure.

FIG. 14 is a schematic diagram of a module for removing the light spot.

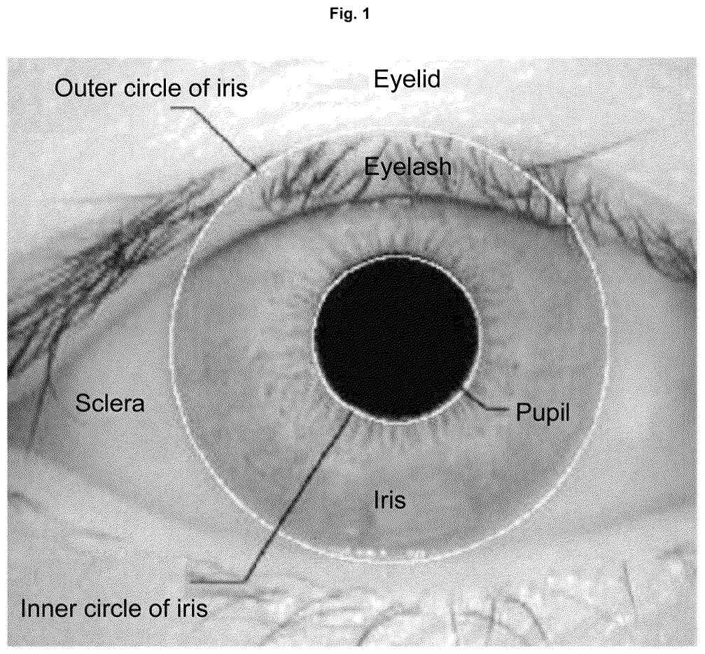

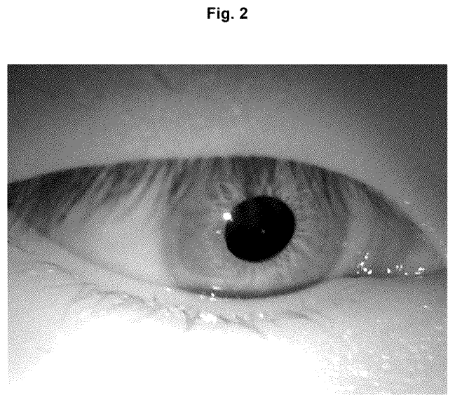

### DETAILED DESCRIPTION OF THE EMBODIMENTS

In order to make problems to be solved, methods and advantages of the present disclosure clearer, a clear and complete description of the technical solutions of the present disclosure will be given below in combination with the drawings and embodiments. Apparently, the embodiments described below are merely a part, but not all, of the embodiments of the present disclosure. Components of the embodiments of the present disclosure, which are generally described and illustrated in the drawings herein, may be arranged and designed in a variety of different configurations. Therefore, the following detailed description of the embodiments of the present disclosure provided in the drawings is not intended to limit the claimed scope of the present disclosure, but merely represents selected embodiments of the present disclosure. All of other embodiments, obtained by those skilled in the art based on the embodiments of the present disclosure without any creative effort, fall into the protection scope of the present disclosure.

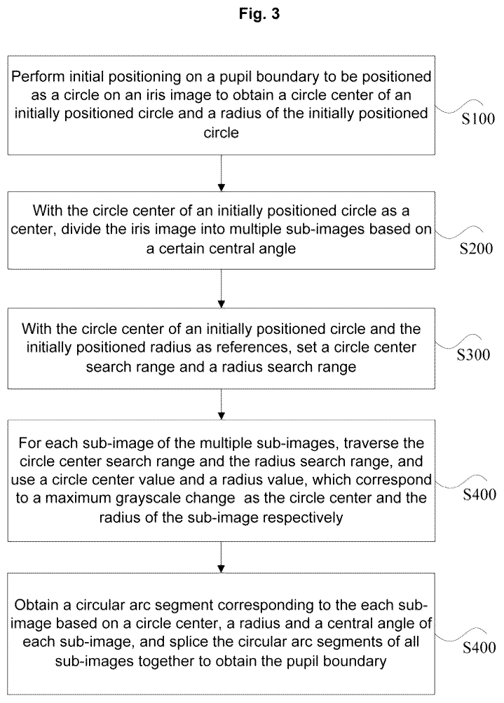

The embodiment of the present disclosure provides a strabismic pupil positioning method, which is used for positioning a strabismic pupil in iris recognition, and of course, may also be used for positioning a normal non-strabismic pupil. As shown in FIG. 3, the method includes:

At step S100: performing initial positioning on a pupil boundary to be positioned as a circle on an iris image to obtain a circle center of an initially positioned circle and the radius of the initially positioned circle.

In the present disclosure, the initial positioning method is not limited. In an embodiment, gradient processing and sharpening are firstly performed on the iris image through using a Sobel algorithm to highlight the pupil boundary to be positioned, and then, through using boundary information and a symmetric radial transformation curve fitting method, the pupil boundary to be positioned is used as the circle to implement the initial positioning.

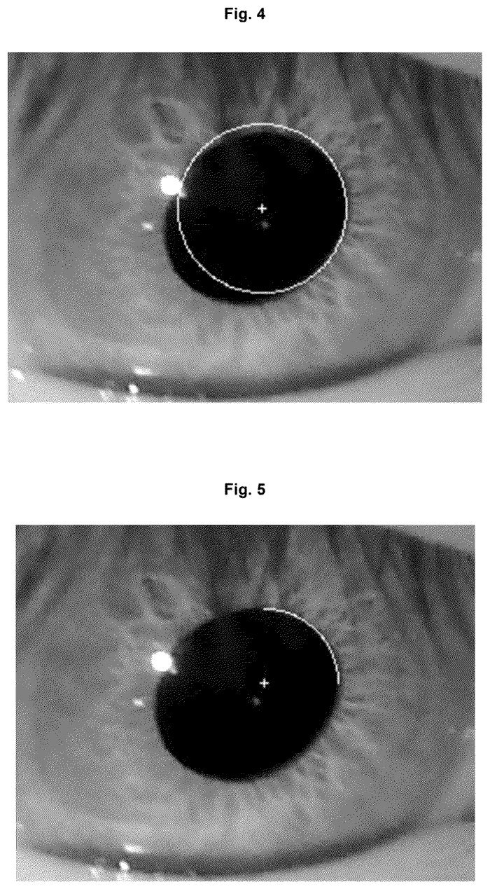

The effect of the initial positioning is shown in FIG. 4, wherein the white circular arc line denotes the initially positioned pupil boundary, the white cross denotes the circle center of the initially positioned circle, the pupil boundary is the boundary of the circle, the coordinates of the circle center are (x₀, y₀), and the radius is r₀.

The method for performing gradient processing and sharpening on the iris image may also select a Canny operator, and the like; and the curve fitting method may also be selected from a least square method, Hough transformation, etc.

At step S200: with the circle center of an initially positioned circle as a center, dividing the iris image into multiple sub-images based on a certain central angle.

Pupil strabismus causes deformation of the pupil boundary, such that the pupil boundary is not a standard circle, and thus an initially positioned circular pupil boundary is not accurate. In order to solve this problem, in the present disclosure, the ins image is divided into multiple sub-images, so that the pupil boundary is cut into multiple segments, since the boundary of the pupil may be actually be regarded as an irregular circular arc, and after being cut into the plurality of segments, a radian boundary of each segment is processed as the circle, which meets the fitting precision of the circle. Then, the whole boundary of the pupil is formed after the pupil boundaries of the multiple segments are spliced together.

At step S300: with the circle center of an initially positioned circle and the initially positioned radius as references, setting a circle center search range and a radius search range.

The coordinates of the circle center of an initially positioned circle are (x₀, y₀), the initially positioned radius is r₀, with the circle center of an initially positioned circle and the initially positioned radius as references, a certain range is expanded to the surrounding to obtain the circle center search range and the radius search range.

In an embodiment, the circle center search range is [x₀−10, x₀+10] and [y₀−10, y₀+10], that is, the range in an x direction of the coordinates of the circle center is [x₀−10, x₀+10], and the range in a y direction is [y₀−10, y₀+10]. The radius search range is [r₁, r₂], and in one value, r₁=r₀−25, r₂=r₀+25.

At step S400: for each sub-image of the multiple sub-images, traversing the circle center search range and the radius search range, and using a circle center value and a radius value corresponding to a maximum gray scale change as the circle center and the radius of the sub-image respectively.

In actual execution, the circle center value may be fixed at first, the radius search range is traversed to find a maximum gray scale change value of the circle center value within the radius search range as a gray scale change value of the circle center, and to obtain a radius value corresponding to the gray scale change value; and then, the circle center search range is traversed, and the above operations are repeated on each circle center value within the circle center search range. Ultimately, the circle center value and the radius value, which correspond to the maximum gray scale change value, are used as the circle center and the radius of the sub-image.

In an embodiment, the circle center is fixed at first, the radius is traversed from r₁ to r₂ to find the maximum gray scale change value within the radius search range as the gray scale change value of the circle center, and to obtain the radius value corresponding to the gray scale change value.

Then, the circle center is changed, the circle center search range[x₀−10, x₀+10] and [y₀−10, y₀+10] is traversed, a gray change value and a radius value are obtained for each circle center value, and a global maximum gray scale change value and a corresponding circle center value and radius value are found, that is, the circle center and the radius of one sub-image are determined.

For each sub-image of the multiple sub-images, the above steps are repeated to obtain the circle center and the radius of each sub-image of the multiple sub-images.

When the circle center search range and the radius search range are traversed, the traversal step length may be set, generally, the traversal step length is 1, and in occasions where precision requirements are not high, the traversal step length may be an integer greater than 1.

At step S500: obtaining a circular arc segment corresponding to the each sub-image of the multiple sub-images based on the circle center, the radius and the central angle of the each sub-image of the multiple sub-images, and splicing the circular arc segments of all sub-images together to obtain the pupil boundary.

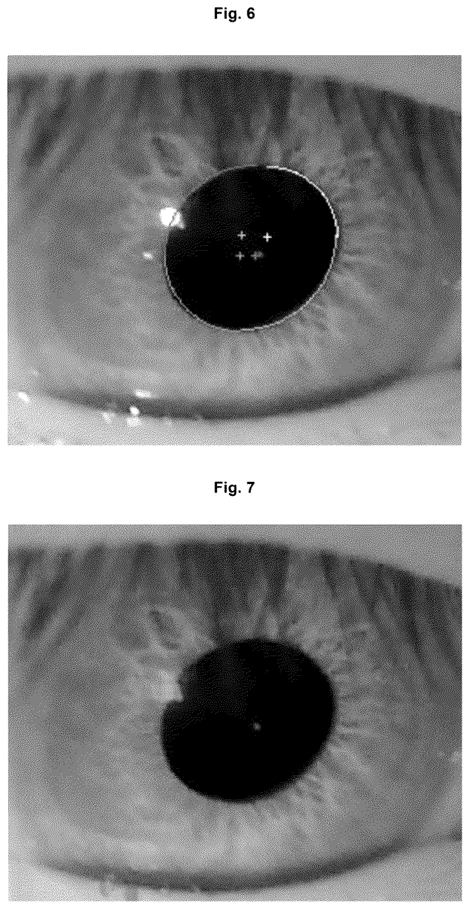

The each sub-image of the multiple sub-images obtains a circle center and a radius, and a segment of circular arc may be obtained based on the central angle of the sub-image, as shown in FIG. 5. The circular arcs of the multiple sub-images are spliced together to obtain the pupil boundary, as shown in FIG. 6.

In the strabismic pupil positioning method of the present disclosure, the circular arc of the pupil with strabismic deformation is divided into multiple angle intervals, and positioning is respectively performed in each angle interval respectively, thereby improving the accuracy of strabismic pupil positioning, and ultimately improving the accuracy of iris recognition. Moreover, when positioning is performed in each angle interval, the positioning of the circle center and the radius does not need to be performed again, but traversal is performed in the surrounding with the circle center of an initially positioned circle and the initially positioned radius as references, thereby shortening the positioning range, and thus having a high positioning speed.

The mode for dividing the sub-images is not limited in the present disclosure. In an embodiment, the iris image is respectively divided into a first sub-image, a second sub-image, a third sub-image and a fourth sub-image based on central angles of [0, π/2], [π/2, π], [π, 3π/2] and [3π/2, 2π]; and the first sub-image, the second sub-image, the third sub-image and the fourth sub-image are respectively in the first quadrant, the second quadrant, the third quadrant and the fourth quadrant.

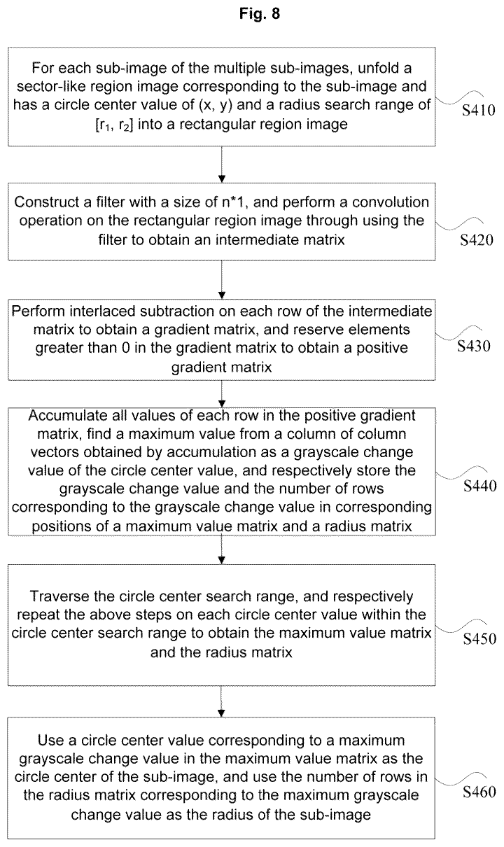

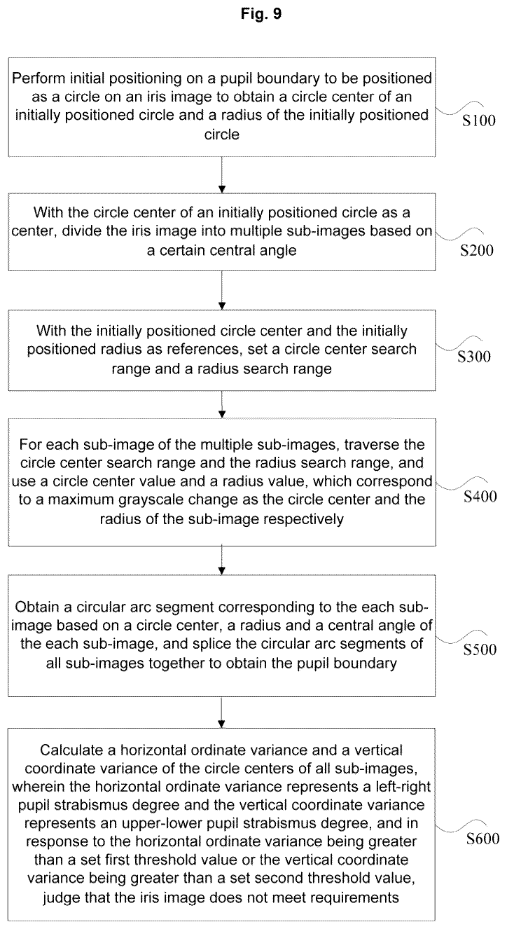

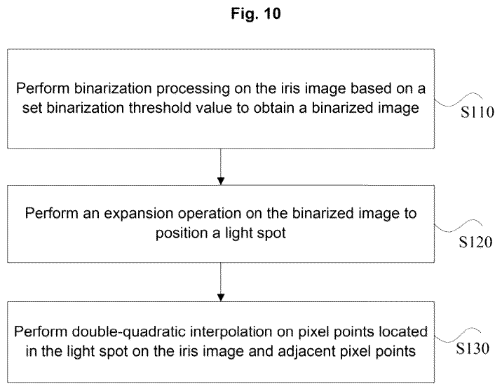

Based on the above sub-image division mode, as shown in FIG. 8, the step S400 includes:
at step S410: for each sub-image of the multiple sub-images, unfolding a sector-like region image which corresponds to the sub-image and has a circle center value of (x, y) and a radius search range of [r₁, r₂] into a rectangular region image.

With the first sub-image as an example, the sector-like region image, which has a circle center value of (x, y), a radius search range of [r₁, r₂] and a central angle of [0, π/2] is unfolded into the rectangular region image.

The image is a sector-like region within a range in which the circle center value is (x, y) and the radius change is [r₁, r₂], the sector-like region image having the central angle of [0, π/2] is unfolded into a rectangular region image having (r₂−r₁+1) rows and multiple columns. The number of columns of the rectangular region image is different due to a different image resolution, and exemplarily, the number of columns may be 60.

In an embodiment, the central angle of the first sub-image is [0, π/2], when the first sub-image is unfolded into the rectangular region image, π/5 may be expanded outwards at both ends of [0, π/2], so that the central angle of the sector-like region is [π/5, π/2+π/5], and some information beyond the edge of the first sub-image is used to make the positioning more accurate. Similarly, the central angles of the sector-like regions corresponding to the second sub-image to the fourth sub-image are respectively [π/2−π/5, π+π/5], [π−π/5, 3π/2+π/5] and [3π/2−π/5, π+π/5].

During the foregoing sub-image unfolding, a normalization method may be used, and the normalization method is:
the Cartesian coordinates (x, y) of the sub-image are converted into polar coordinates (r, θ), wherein the conversion formula is:

$$\{ \begin{matrix}x ( r , θ ) = ( 1 - r ) {x}_{out} ( θ ) + {rx}_{in} ( θ ) \\ y ( r , θ ) = ( 1 - r ) {y}_{out} ( θ ) + {rx}_{in} ( θ )\end{matrix}$$

wherein r∈[0, 1], θ∈[0, 2π], (xᵢₙ, yᵢₙ) and (xₒᵤₜ, yₒᵤₜ) respectively represent a start point and an end point in a θ direction.

At step S420: constructing a filter with a size of n*1, and performing a convolution operation on the rectangular region image through using the filter to obtain an intermediate matrix.

The filter is a matrix having n rows and one column, the convolution operation is performed on the rectangular region image via the filter, the gray scale value of each row of the rectangular region image is replaced with a statistical value of multiple rows around the row, and the value of n be set as needed.

In an embodiment, the filter is [1, 1, 1, 1, 1]′, and the gray scale value of each row after convolution is the statistical value of 5 rows in the surrounding. In the present disclosure, a point division operation may also be performed on a convolution result, for example, the gray scale value of each point is divided by 5, so that the gray scale value of each point is an average of effective gray scale values of 5 rows in the vicinity each point.

At step S430: performing interlaced subtraction on each row of the intermediate matrix to obtain a gradient matrix, and reserving elements greater than 0 in the gradient matrix to obtain a positive gradient matrix.

The interlaced subtraction refers to reducing the first row in the third row, reducing the second row in the fourth row, and so on, so as to obtain the gradient matrix. Since a pupil gray scale is less than an iris gray scale, values greater than 0 in the gradient matrix are taken to obtain the positive gradient matrix.

At step S440: accumulating all values of each row in the positive gradient matrix, finding a maximum value from a column of column vectors obtained by accumulation as a gray scale change value of the circle center value, and respectively storing the gray scale change value and the number of rows corresponding to the gray scale change value in corresponding positions of a maximum value matrix and a radius matrix.

In the step S440, the each row of the positive gradient matrix is accumulated, then the values of all rows of the column vector obtained by accumulation are compared, the maximum value of all rows is the gray scale change value, and the number of rows corresponding to the maximum value of all rows is the corresponding position of the pupil boundary, that is, the radius.

At step S450: traversing the circle center search range, and respectively repeating the above steps S410 to S440 on each circle center value within the circle center search range to obtain the maximum value matrix and the radius matrix, wherein each position of the maximum value matrix and the radius matrix corresponds to one circle center value.

At step S460: using a circle center value corresponding to a maximum gray scale change value in the maximum value matrix as the circle center of the sub-image, and using the number of rows in the radius matrix corresponding to the maximum gray scale change value as the radius of the sub-image.

For the first sub-image, the maximum value in the maximum value matrix is the maximum value of the global gray scale change, the number of rows in the corresponding radius matrix is the corresponding position of the pupil boundary, that is, the radius, and the circle center value corresponding to the maximum value of the global gray scale change is the circle center, as shown in FIG. 5. The circle centers and radiuses of the ultimately obtained first sub-image to the fourth sub-image are respectively (x1, y1, r1), (x2, y2, r2), (x3, y3, r3) and (x4, y4, r4), as shown in FIG. 6.

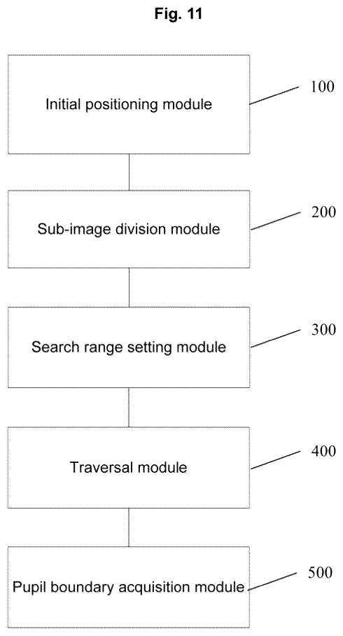

As an improvement of the embodiment of the present disclosure, as shown in FIG. 9, the method further includes:

At step S600: calculating a horizontal ordinate variance and a vertical coordinate variance of the circle centers of all sub-images, wherein the horizontal ordinate variance represents a left-right pupil strabismus degree and the vertical coordinate variance represents an upper-lower pupil strabismus degree, and in response to the horizontal ordinate variance being greater than a set first threshold value or the vertical coordinate variance being greater than a set second threshold value, judging that the iris image does not meet requirements.

In the step S600, whether the iris image is strabismic and the strabismus degree are judged by using the coordinates of the circle centers of the plurality of sub-images. With the obtained (x1, y1, r1), (x2, y2, r2), (x3, y3, r3) and (x4, y4, r4) as an example, the judgment stands are as follows:
when the variance of the four numbers of (y1, y2, y3, y4) is greater than the second threshold value M, it is considered that the upper-lower strabismus is too large, and thus the iris image does not meet the requirements; and when the variance of the four numbers of (x1, x2, x3, x4) is greater than the first threshold value N, it is considered that the left-right strabismus is too large, and thus the iris image does not meet the requirements.
M and N may be set based on actual requirements, and the threshold values M and N may be generally set based on the case where the comparison is successful in iris recognition. When the horizontal ordinate variance is greater than N or the vertical coordinate variance is greater than M, the strabismus is too large, and the iris recognition cannot be successfully compared.

There is often a light spot in the iris image, and since the gradient of the light spot on the pupil boundary is relatively large, the pupil positioning effect is affected. In order to remove the influence of light spot noise on boundary fitting, as shown in FIG. 10, after initial positioning, and before dividing the sub-images, the method in the present disclosure further includes:

At step S110: performing binarization processing on the iris image at a set binarization threshold value to obtain a binary image.

In an embodiment, the binarization threshold value is set to be 250, binarization is performed with 250 as the threshold value, a position greater than 250 is set to be 1 (or 255), and other positions are set to be 0 to obtain the binary image, the position 1 on the binary image represents a light spot, and the position and size of the light spot may be roughly determined.

At step S120: performing an expansion operation on the binary image to position the light spot.

The expansion is similar to “field expansion”, a highlight region or white portion in the image is expanded, such that a running result diagram is greater than the highlight region of an original diagram. In the step S120, by means of the expansion operation, voids in the light spot or serrations on the edge of the light spot may be removed.

At step S130: performing double-quadratic interpolation on pixel points located in the light spot on the iris image and adjacent pixel points.

In the step S130, pixel values around the light spot are used for performing an operation to replace the values in the light spot to achieve the purpose of removing the light spot, and the effect after the light spot is removed is shown in FIG. 7.

In the present disclosure, a circular arc based on pupil deformation is segmented based on multiple angle intervals, and each segment of pupil boundary is regarded as a circular arc for positioning, thereby improving the accuracy of strabismic pupil positioning, and ultimately improving the accuracy of iris recognition. Moreover, for some iris images with serious strabismus, the iris is seriously deformed, therefore the recognition is greatly affected, and the strabismus degrees of the images may be judged based on multiple groups of coordinates of pupil positioning.

The embodiment of the present disclosure provides a strabismic pupil positioning apparatus, and as shown in FIG. 11, the apparatus includes:
an initial positioning module 100, configured to perform initial positioning on a pupil boundary to be positioned as a circle on an iris image to obtain a circle center of an initially positioned circle and the radius of the initially positioned circle;
a sub-image division module 200, configured to divide the iris image into multiple sub-images based on a certain central angle with the circle center of an initially positioned circle as a center;
a search range setting module 300, configured to set a circle center search range and a radius search range with the circle center of an initially positioned circle and the initially positioned radius as references;
a traversal module 400, configured to traverse the circle center search range and the radius search range, and use a circle center value and a radius value corresponding to a maximum gray scale change as the circle center and the radius of the sub-image respectively, for each sub-image of the multiple sub-images;
a pupil boundary acquisition module 500, configured to obtain a circular arc segment corresponding to the each sub-image based on a circle center, a radius and a central angle of each sub-image, and splice the circular arc segments of all sub-images together to obtain the pupil boundary.

In the present disclosure, a circular arc of the pupil with strabismic deformation is divided into multiple angle intervals, and positioning is respectively performed in each angle interval, thereby improving the accuracy of strabismic pupil positioning, and ultimately improving the accuracy of iris recognition. Moreover, when positioning is performed in each angle interval, the positioning of the circle center and the radius does not need to be performed again, but traversal is performed in the surrounding with the circle center of an initially positioned circle and the initially positioned radius as references, thereby shortening the positioning range, and thus having a high positioning speed.

The mode for dividing the sub-images is not limited in the present disclosure. In an embodiment, the iris image is respectively divided into a first sub-image to a fourth sub-image based on central angles of [0, π/2], [π/2, π], [π, 3π/2] and [3π/2, 2π], and the first sub-image to the fourth sub-image are respectively in the first quadrant to the fourth quadrant.

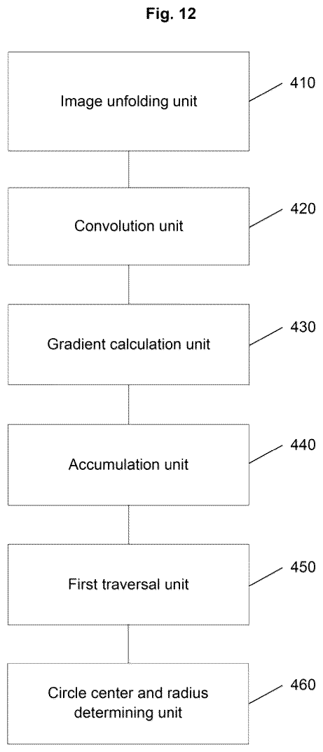

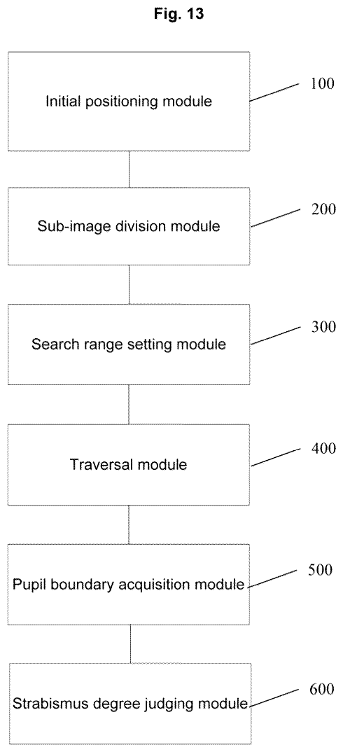

Based on the above sub-image division mode, as shown in FIG. 12, the traversal module 400 includes:
an image unfolding unit 410, configured to unfold a sector-like region image which corresponds to the sub-image and has a circle center value of (x, y) and a radius search range of [r₁, r₂] into a rectangular region image for the each sub-image of the multiple sub-images;
a convolution unit 420, configured to construct a filter with a size of n*1, and perform a convolution operation on the rectangular region image through using the filter to obtain an intermediate matrix;
a gradient calculation unit 430, configured to perform interlaced subtraction on each row of the intermediate matrix to obtain a gradient matrix, and reserve elements greater than 0 in the gradient matrix to obtain a positive gradient matrix;
an accumulation unit 440, configured to accumulate all values of each row in the positive gradient matrix, find a maximum value from a column of column vectors obtained by accumulation as a gray scale change value of the circle center value, and respectively store the gray scale change value and the number of rows corresponding to the gray scale change value in corresponding positions of a maximum value matrix and a radius matrix;
a first traversal unit 450, configured to traverse the circle center search range, and respectively repeat the execution steps of the image unfolding unit 410, the convolution unit 420, the gradient calculation unit 430 and the accumulation unit 440 on each circle center value within the circle center search range to obtain the maximum value matrix and the radius matrix, wherein each position of the maximum value matrix and the radius matrix correspond to one circle center value;
a circle center and radius determining unit 460, configured to use a circle center value corresponding to a maximum gray scale change value in the maximum value matrix as the circle center of the sub-image, and use the number of rows in the radius matrix corresponding to the maximum gray scale change value as the radius of the sub-image.

In an embodiment, when the sector-like region image is unfolded into the rectangular region image, the central angles of sector-like regions corresponding to the first sub-image to the fourth sub-image are respectively [−π/5, π/2+π/5], [π/2−π/5, π+π/5], [π−π/5, 3π/2+π/5] and [3π/2−π/5, π+π/5].

The circle center search range is [x₀−10, x₀+10] and [y₀−10, y₀+10], and the radius search range is [r₁, r₂], wherein (x₀, y₀) denotes the circle center of an initially positioned circle, r₁=r₀−25, r₂=r₀+25, and r₀ denotes the initially positioned radius.

As an improvement of the embodiment of the present disclosure, as shown in FIG. 13, the apparatus further includes:
a strabismus degree judging module 600, configured to calculate a horizontal ordinate variance and a vertical coordinate variance of the circle centers of all sub-images, wherein the horizontal ordinate variance represents a left-right pupil strabismus degree and the vertical coordinate variance represents an upper-lower pupil strabismus degree, and in response to the horizontal ordinate variance being greater than a set first threshold value or the vertical coordinate variance being greater than a set second threshold value, judge that the iris image does not meet requirements.

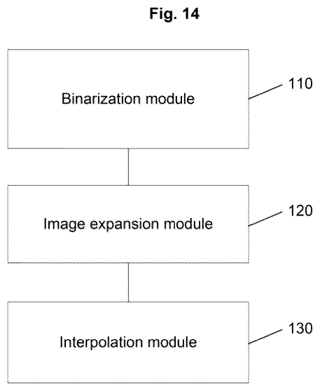

In order to remove the influence of a light spot, as shown in FIG. 14, the apparatus of the present disclosure further includes:
a binarization module 110, configured to perform binarization processing on the iris image based on a set binarization threshold value, so as to obtain a binary image;
an image expansion module 120, configured to perform an expansion operation on the binary image to position the light spot; and
an interpolation module 130, configured to perform double-quadratic interpolation on pixel points located in the light spot on the iris image and adjacent pixel points.

In the present disclosure, a circular arc based on pupil deformation is segmented based on multiple angle intervals, and each segment of pupil boundary is regarded as the circular arc for positioning, thereby improving the accuracy of strabismic pupil positioning, and ultimately improving the accuracy of iris recognition. Moreover, for some iris images with serious strabismus, the iris is seriously deformed, therefore the recognition is greatly affected, and the strabismus degrees of the images may be judged based on multiple groups of coordinates of pupil positioning.

With regard to the apparatus provided in the embodiment of the present disclosure, the implementation principles and the generated technical effects are the same as those in the strabismic pupil positioning method, therefore for a brief description, parts which are not mentioned in the apparatus embodiment may refer to corresponding content in the foregoing method. Those skilled in the art to which the present disclosure belongs may understand that, for the convenience and conciseness of description, the working process of the apparatuses and units described above may refer to corresponding processes in the strabismic pupil positioning method, and thus will not be repeated herein.

The method of strabismic pupil positioning provided in the present disclosure may implement service logic by means of a computer program and record same on a storage medium, and the storage medium may be read and executed by a computer to implement the effects of the solutions described in the strabismic pupil positioning method of the present specification. Therefore, the present disclosure further provides a computer-readable storage medium, configured to store processor-executable program, and when executed by the processor, the program implements the steps of the strabismic pupil positioning method.

In the present disclosure, the circular arc of the pupil with strabismic deformation is divided into multiple angle intervals, and positioning is respectively performed in each angle interval, thereby improving the accuracy of strabismic pupil positioning, and ultimately improving the accuracy of iris recognition. Moreover, when positioning is performed in each angle interval, the positioning of the circle center and the radius does not need to be performed again, but traversal is performed in the surrounding with the circle center of an initially positioned circle and the initially positioned radius as references, thereby shortening the positioning range, and thus having a high positioning speed.

The storage medium may include a physical apparatus for storing information, which usually stores information, after digitizing same, through using media in modes such as electrical, magnetic or optical. The storage medium may include: an apparatus for storing the information in an electric energy mode, for example, multiple memories such as an RAM, an ROM, or the like; an apparatus for storing the information in a magnetic energy mode, for example, a hard disk, a floppy disk, a magnetic tape, a magnetic core memory, a magnetic bubble memory and a USB flash disk; and an apparatus for storing the information in an optical mode, for example, a CD or DVD. Of course, there are readable storage media in other manners, such as a quantum memory, a graphene memory, etc.

The storage medium described above may further include other embodiments based on the description of the strabismic pupil positioning method, and the implementation principles and the generated technical effects of the present embodiment are the same as those in the strabismic pupil positioning method, reference may be made to related description in the strabismic pupil positioning method, and thus will not be repeated herein.

The present disclosure further provides a device for strabismic pupil positioning, the device may be a separate computer, and may also include an actual operating apparatus or the like using one or more of the methods or one or more apparatus embodiments of the present specification. The device for strabismic pupil positioning may include at least one processor and a memory for storing a computer-executable program, and when executing the program, the processor implements the steps of the strabismic pupil positioning method in any one or more Embodiments 1.

In the present disclosure, a circular arc of the pupil with strabismic deformation is divided into multiple angle intervals, and positioning is respectively performed in each angle interval, thereby improving the accuracy of strabismic pupil positioning, and ultimately improving the accuracy of iris recognition. Moreover, when positioning is performed in each angle interval, the positioning of the circle center and the radius does not need to be performed again, but traversal is performed in the surrounding with the circle center of an initially positioned circle and the initially positioned radius as references, thereby shortening the positioning range, and thus having a high positioning speed.

The device described above may further include other embodiments based on the description of the strabismic pupil positioning method, and the implementation principles and the generated technical effects of the present embodiment are the same as those in the strabismic pupil positioning method, reference may be specifically made to related description in the strabismic pupil positioning method, and thus will not be repeated herein.

Ultimately, it should be noted that, the embodiments described above are merely specific embodiments of the present disclosure, and are used to illustrate the technical solutions of the present disclosure, rather than limiting the technical solutions of the present disclosure, therefore the protection scope of the present disclosure is not limited thereto. Although the present disclosure is described in detail with reference to the foregoing embodiments, those ordinary skilled in the art should understand that, any one who is familiar with this art may still modify or easily conceive of changes to the technical solutions recorded in the foregoing embodiments, or equivalently replace some of the technical features therein within the technical scope disclosed in the present disclosure; and these modifications, changes or substitutions do not make the essence of corresponding technical solutions depart from the spirit and scope of the technical solutions of the embodiments of the present disclosure, and all should be encompassed within the protection scope of the present disclosure. Therefore, the protection scope of the present disclosure shall be subject to the protection scope of the claims.

What is claimed is:

1. A strabismic pupil positioning method, comprising:
performing initial positioning on a pupil boundary to be positioned as a circle on an iris image to obtain a circle center of an initially positioned circle and a radius of the initially positioned circle;
with the circle center of the initially positioned circle as a center, dividing the iris image into multiple sub-images based on a certain central angle;
with the circle center of the initially positioned circle and the radius of the initially positioned circle as references, setting a circle center search range and a radius search range;
for each sub-image of the multiple sub-images, traversing the circle center search range and the radius search range, and using a circle center value and a radius value, which correspond to a maximum gray scale change as the circle center and the radius of the sub-image respectively;
obtaining a circular arc segment corresponding to the each sub-image based on a circle center, a radius and a central angle of the each sub-image, and splicing circular arc segments of all sub-images together to obtain the pupil boundary.

2. The strabismic pupil positioning method as claimed in claim 1, wherein for each sub-image of the multiple sub-images, traversing the circle center search range and the radius search range, and using a circle center value and a radius value corresponding to a maximum gray scale change as the circle center and the radius of the sub-image respectively comprises:
for each sub-image of the multiple sub-images, unfolding a sector-like region image corresponding to the sub-image and has a circle center value of (x, y) and a radius search range of [r₁, r₂] into a rectangular region image;
constructing a filter with a size of n*1, and performing a convolution operation on the rectangular region image through using the filter to obtain an intermediate matrix;
performing interlaced subtraction on each row of the intermediate matrix to obtain a gradient matrix, and reserving elements greater than 0 in the gradient matrix to obtain a positive gradient matrix;
accumulating all values of each row in the positive gradient matrix, finding a maximum value from a column of column vectors obtained by accumulation as a gray scale change value of the circle center value, and respectively storing the gray scale change value and the number of rows corresponding to the gray scale change value in corresponding positions of a maximum value matrix and a radius matrix;
traversing the circle center search range, and respectively repeating the above steps on each circle center value within the circle center search range to obtain the maximum value matrix and the radius matrix;
using a circle center value corresponding to a maximum gray scale change value in the maximum value matrix as the circle center of the sub-image, and using the number of rows in the radius matrix corresponding to the maximum gray scale change value as the radius of the sub-image.

3. The strabismic pupil positioning method as claimed in claim 2, wherein the iris image is respectively divided into a first sub-image, a second sub-image, a third sub-image and a fourth sub-image based on central angles of [0, π/2], [π/2, π], [π, 3π/2] and [3π/2, 2π]; and in response to the sector-like region image being unfolded into the rectangular region image, the central angles of sector-like regions respectively corresponding to the first sub-image, the second sub-image, the third sub-image and the fourth sub-image are respectively [−π/5, π/2+π/5], [π/2−π/5, π+π/5], [π−π/5, 3π/2+π/5] and [3π/2−π/5, π+π/5];
the circle center search range is [x₀−10, x₀+10] and [y₀−10, y₀+10], and the radius search range is [r₁, r₂], wherein (x₀, y₀) denotes the circle center of the initially positioned circle, r₁=r₀−25, r₂=r₀+25, and r₀ denotes the radius of the initially positioned circle.

4. The strabismic pupil positioning method as claimed in claim 1, wherein the method further comprises:
calculating a horizontal ordinate variance and a vertical coordinate variance of circle centers of all sub-images, wherein the horizontal ordinate variance represents a left-right pupil strabismus degree and the vertical coordinate variance represents an upper-lower pupil strabismus degree, and in response to the horizontal ordinate variance being greater than a set first threshold value or the vertical coordinate variance being greater than a set second threshold value, judging that the iris image does not meet requirements.

5. The strabismic pupil positioning method as claimed in claim 1, wherein before the iris image is divided into the multiple sub-images based on the certain central angle with the circle center of the initially positioned circle as the center, the method further comprises:
Performing binarization processing on the iris image based on a set binarization threshold value to obtain a binary image;
performing an expansion operation on the binary image to position a light spot;
performing double-quadratic interpolation on pixel points located in the light spot on the iris image and adjacent pixel points.

6. A strabismic pupil positioning apparatus, comprising:
an initial positioning module, configured to perform initial positioning on a pupil boundary to be positioned as a circle on an iris image to obtain the circle center of a circle center of an initially positioned circle and a radius of the initially positioned circle;
a sub-image division module, configured to divide the iris image into multiple sub-images based on a certain central angle with the circle center of the initially positioned circle as a center;
a search range setting module configured to set a circle center search range and a radius search range with the circle center of the initially positioned circle and the radius of the initially positioned circle as references;
a traversal module, configured to traverse the circle center search range and the radius search range, and use, as the circle center and the radius of the sub-image, a circle center value and a radius value, which correspond to a maximum gray scale change as the circle center and the radius of the sub-image respectively, for each sub-image of the multiple sub-images;
a pupil boundary acquisition module, configured to obtain a circular arc segment corresponding to each sub-image based on the circle center, the radius and the central angle of each sub-image, and splice the circular arc segments of all sub-images together to obtain the pupil boundary.

7. The strabismic pupil positioning apparatus as claimed in claim 6, wherein the traversal module comprises:
an image unfolding unit configured to unfold a sector-like region image which corresponds to the sub-image and has a circle center value of (x, y) and a radius search range of [r₁, r₂] into a rectangular region image for the each sub-image of the multiple sub-images;
a convolution unit, configured to construct a filter with a size of n*1, and perform a convolution operation on the rectangular region image through using the filter to obtain an intermediate matrix;
a gradient calculation unit, configured to perform interlaced subtraction on each row of the intermediate matrix to obtain a gradient matrix, and reserve elements greater than 0 in the gradient matrix to obtain a positive gradient matrix;
an accumulation unit, configured to accumulate al values of each row in the positive gradient matrix, find a maximum value from a column of column vectors obtained by accumulation as a gray scale change value of the circle center value, and respectively store the gray scale change value and the number of rows corresponding to the gray scale change value in corresponding positions of a maximum value matrix and a radius matrix;
a first traversal unit, configured to traverse the circle center search range, and obtain the maximum value matrix and the radius matrix for each circle center value within the circle center search range;
a circle center and radius determining unit, configured to use a circle center value corresponding to a maximum gray scale change value in the maximum value matrix as the circle center of the sub-image, and use the number of rows in the radius matrix corresponding to the maximum gray scale change value as the radius of the sub-image.

8. The strabismic pupil positioning apparatus as claimed in claim 6, wherein the apparatus further comprises:
a strabismus degree judging module, configured to calculate a horizontal ordinate variance and a vertical coordinate variance of the circle centers of all sub-images, wherein the horizontal ordinate variance represents a left-right pupil strabismus degree and the vertical coordinate variance represents an upper-lower pupil strabismus degree, and in response to the horizontal ordinate variance being greater than a set first threshold value or the vertical coordinate variance being greater than a set second threshold value, judge that the iris image does not meet the requirements.

9. A computer-readable storage medium, configured to store a processor-executable program, wherein when executed by the processor, cause the processor to:
perform initial positioning on a pupil boundary to be positioned as a circle on an iris image to obtain the circle center of the initially positioned circle and a radius of the initially positioned circle;
with the circle center of the initially Positioned circle as a center, divide the iris image into multiple sub-images based on a certain central angle;
with the circle center of the initially positioned circle and the radius of the initially Positioned circle as references, set a circle center search range and a radius search range;
for each sub-image of the multiple sub-images, traverse the circle center search range and the radius search range, and using a circle center value and a radius value, which correspond to a maximum gray scale chance as the circle center and the radius of the sub-image respectively;
obtain a circular arc segment corresponding to the each sub-image based on a circle center, a radius and a central angle of the each sub-image, and splic circular arc segments of al sub-images together to obtain the pupil boundary.

10. (canceled)

11. The strabismic pupil positioning method as claimed in claim 1, wherein before initial positioning is performed on the pupil boundary to be positioned as the circle on an iris image to obtain a circle center of an initially positioned circle and the radius of the initially positioned circle, the method further comprises:
performing gradient treatment and sharpening on the iris image through using an algorithm to highlight the pupil boundary to be positioned.

12. The strabismic pupil positioning method as claimed in claim 2, wherein for each sub-image of the multiple sub-images, unfolding a sector-like region image corresponding to the sub-image and has a circle center value of (x, y) and a radius search range of [r₁, r₂] into a rectangular region image comprises:
for each sub-image of the multiple sub-images, unfolding a sector-like region image corresponding to the sub-image and has a circle center value of (x, y) and a radius search range of [r₁, r₂] into a rectangular region image with (r₂−r₁+1) rows and multiple columns.

13. The strabismic pupil positioning method as claimed in claim 2, wherein performing the convolution operation on the rectangular region image through using the filter to obtain the intermediate matrix comprises:
performing a convolution operation on the rectangular region image through using the filer to a convolution result;
performing a point division operation on the convolution result to obtain the intermediate matrix.
